(19) United States
(12) Patent Application Publication
(10) Pub. No.: US 2012/0097586 A1
(43) Pub. Date: Apr. 26, 2012

(54) Device for filtering and deaeration of fuel oil with return changeover valve

(76) Inventors: Thomas HEINZ, Zaberfeld (DE); Eugen Mayer, Offenau (DE)

(21) Appl. No.: 13/277,949

(22) Filed: Oct. 20, 2011

(30) Foreign Application Priority Data
Oct. 26, 2010 (EP) 10188860.0

(51) Int. Cl. B01D 35/02; B01D 35/147; B01D 29/90

(52) U.S. Cl. 210/130; 210/172.6; 210/136

(57) ABSTRACT

In a device (1) for filtering and deaeration of liquid fuel, in particular fuel oil, comprising a tank connection (2) for connection to an oil tank, a feed connection (3) for connection to an oil burner feed, a return connection (4) for connection to an oil burner fuel return, a feed line (5) connecting the tank connection (2) to the feed connection (3), an oil filter (6) disposed in the feed line (5), and a return line (8) connecting the return connection (4) to the feed line (5), in accordance with the invention, the return line (8) is connected to the feed line (5) by means of a return changeover valve (14) that can be switched between two valve positions and connects the return line (8) to the feed line (5) in one of the valve positions upstream of the oil filter (6) and connects the return line (9) to the feed line (5) in the other valve position downstream of the oil filter (6).

The present invention relates to a device for filtering liquid fuel, in particular fuel oil, comprising a tank connection for connection to a fuel tank, a feed connection for connection to a burner feed, a return connection for connection to a burner fuel return, a feed line connecting the tank connection to the feed connection, a fuel filter disposed in the feed line and a return line connecting the return connection to the feed line.

A device for filtering and also for deaeration of fuel oil is disclosed e.g. in DE 39 04 963 A1.

In this conventional filtering and deaeration device and also in other available filtering and deaeration devices, the fuel oil deaeration device is arranged downstream of the oil filter. Even in combination devices, only the fuel oil or the liquid fuel drawn by the tank is filtered, i.e. the liquid fuel is filtered in the feed stage. In contrast to a classic two-line filter, systems that are operated as single-line systems increasingly have the problem that air accumulates on the outer side of the filter element. Since in single-line operation only the amount that is actually consumed by the burner is drawn through the filter element, the volume flow is correspondingly reduced. The pressure difference between the outer and inner sides of the filter element is then only marginal. Due to the fact that the surface of the filter element is completely wetted with fuel, the air bubbles can no longer penetrate through this liquid film. It is thereby inevitable that relatively large amounts of air collect in the filter cup, however, only in the outer area of the filter element.

In contrast thereto, it is the object of the present invention to further improve a filtering device of the above-mentioned type and, in particular, prevent large amounts of air from accumulating in the filtering area.

This object is achieved in accordance with the invention in that the return line is connected to the feed line by means of a return changeover valve that can be switched between two valve positions and connects the return line to the feed line in one of the valve positions upstream of the fuel filter and connects the return line to the feed line in the other valve position downstream of the fuel filter.

In accordance with the invention, the return changeover valve connects the return line to the feed line electively downstream of the fuel filter for single filtration of the fuel to be supplied to the burner, or connects it upstream of the fuel filter for multiple filtration of the fuel to be supplied to the burner. Multiple filtration consequently yields, in particular, the following advantages:
no air or a substantially smaller amount of air accumulated in the filter cup, mainly in case of relatively small volume flows.
substantial improvement of the grade of filtration for smaller flow rates, since multiple filtration improves e.g. the grade of filtration of a 5/20 μm element (5 μm with 50% fractional collection efficiency/20 μm with 99% fractional collection efficiency) from 20 μm to 5 μm.
the fuel filter can electively be adjusted to larger or smaller flow rates. For this reason, optimum filtration is realized with small consumers. This is important for interference-free operation for small-scale consumers with extremely small nozzle consumption of e.g. 1.2 l/h (minimum bore cross-section in the burner nozzle). Large-scale consumers can switch over to single filtration, which reduces the pressure difference. For high consumption, the grade of filtration does not need to be optimum, since nozzle bores of a corresponding large size are used. For systems with small consumption, the maximum possible grade of filtration can be achieved with the filtering elements that are available on the market.

A fuel deaeration device is advantageously arranged in the return line and the return changeover valve is arranged in the return line upstream of the fuel deaeration device.

In a preferred embodiment, which can also be provided alone by itself in accordance with the invention, the feed line has a check valve with integrated pressure relief between the tank connection and the fuel filter. This prevents dangerous excess pressures that can occur e.g. in case of incorrect connection of the filtering and deaeration device (feed and return hose connections mixed up).

In a further preferred embodiment, which can also be provided alone by itself in accordance with the invention, a fuel deaeration device is arranged in the return line, the return changeover valve is arranged in the return line upstream of the fuel deaeration device, and a bypass valve is provided between the fuel deaeration device an the feed line, through which bypass valve the fuel deaeration device can be connected to the feed line. An open connection between return and feed side is produced by opening the bypass valve, so that the fuel can be correspondingly discharged. Aeration can thereby be realized via a deaeration valve of the fuel deaeration device. It is e.g. required to drain the fuel when the burner hoses are periodically replaced, in which case liquid fuel always inevitably escaped, causing corresponding soiling and unpleasant odors.

Further advantages and advantageous embodiments of the subject matter of the invention can be extracted from the description, the drawing and the claims. The features mentioned above and below can be used individually or collectively in arbitrary combination. The embodiment shown and described is not to be understood as exhaustive enumeration but has exemplary character for describing the invention.

In the drawing:

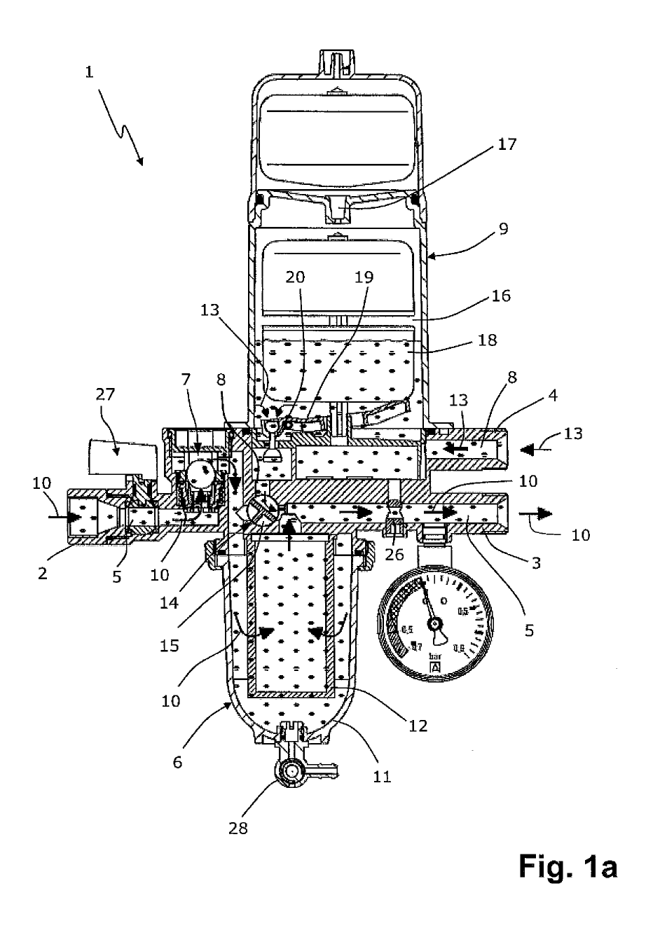

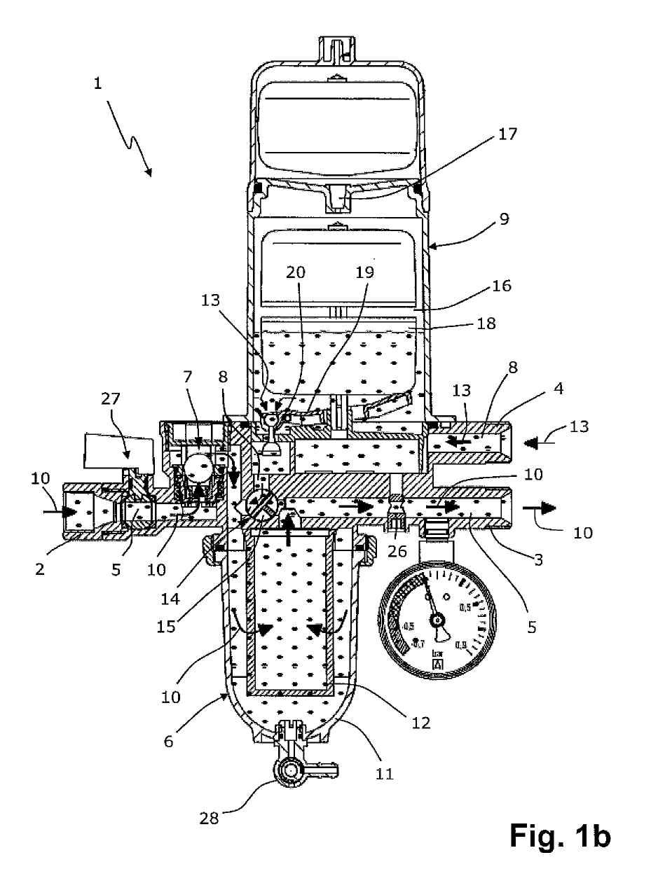

FIGS. 1a, 1b show the inventive device for filtering and de-aeration fuel oil with a return changeover valve in the valve position for single filtration (FIG. 1a) and in the valve position for multiple filtration (FIG. 1b);

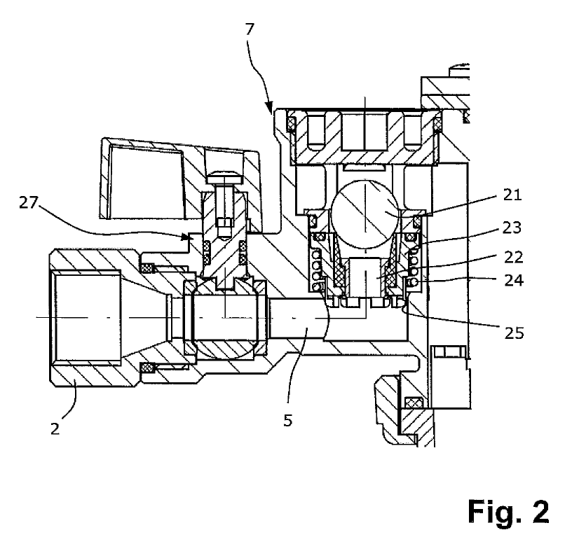

FIG. 2 shows a detailed view of a check valve illustrated in FIG. 1 with integrated pressure relief; and

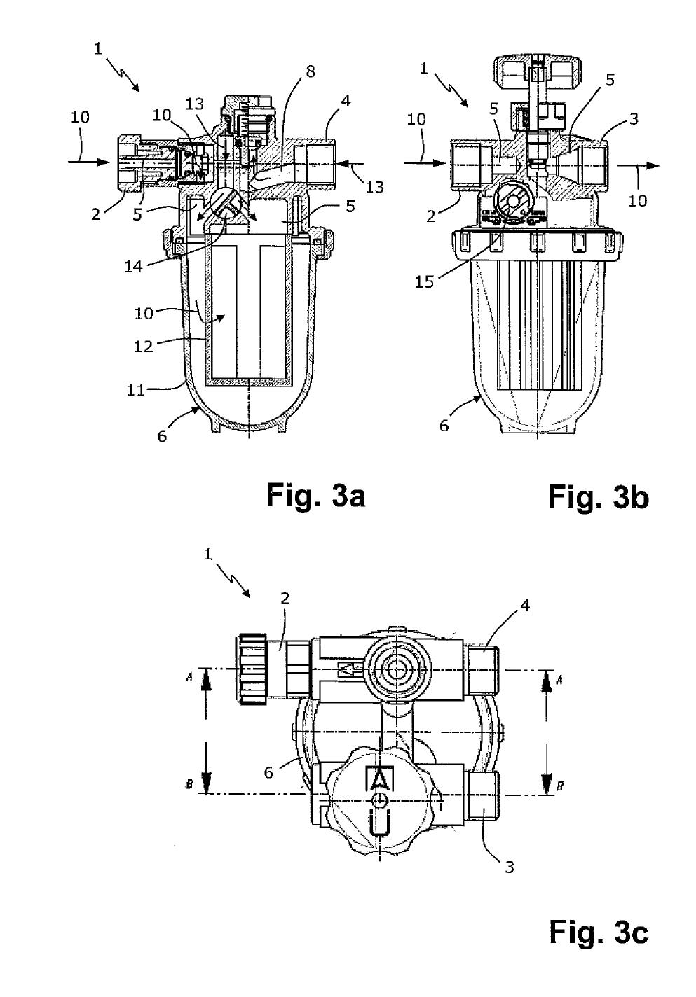

FIGS. 3a-3c show two longitudinal sections (FIGS. 3a, 3b) in correspondence with the intersecting lines A-A, B-B in FIG. 3c of an inventive device for filtering fuel oil with a return changeover valve for switching over between single and multiple filtrations.

The device 1 illustrated in FIGS. 1a and 1b is used for filtering and deaeration of heating oil that is extracted from an oil tank and supplied to an oil burner.

The filtering and deaeration device 1 has a tank connection 2 for connection to the oil tank, a feed connection 3 for connection to the oil burner feed leading to the oil burner, a return connection 4 for connection to an oil burner fuel return returning from the oil burner, a feed line 5 connecting the tank connection 2 to the feed connection 3, an oil filter 6 arranged in the feed line 5, a check valve 7 with integrated pressure relief arranged in the feed line 5 between the tank connection 2 and the oil filter 6, a return line 8 connecting the return connection 4 to the feed line 5, and an oil deaeration device 9 arranged in the return line 8.

As indicated by the flow arrows 10, the oil drawn from the oil tank flows into the feed line 5 via the tank connection 2, passes the check valve 7 and then enters into the filter cup 11 of the oil filter 6. The oil flows through the filter element 12 contained in the filter cup 11 from the outside to the inside, and the subsequently filtered oil continues to flow to the feed connection 3 and is supplied to the oil burner for combustion. As is indicated by the flow arrows 13, the delivered excess oil that is not supplied for combustion is supplied from the oil burner via the return connection 4 into the return line 8 and, after passage of the oil deaeration device 9, again to the feed line 5 via a return changeover valve 14. The air that is resolved in the excess return oil is extracted in the oil deaeration device 9. This is explained in more detail below with reference to the description and to the function of the oil deaeration device 9.

The return changeover valve 14 is disposed in the return line 8 upstream of the oil deaeration device 9 and can be manually switched between two valve positions. In one valve position, illustrated in FIG. 1a, the return changeover valve 14 connects the return line 8 to the feed line 5 upstream of the oil filter 6 and in the other valve position, illustrated in FIG. 1b, it connects the return line 8 to the feed line 5 downstream of the oil filter 6. The return changeover valve 14 has a valve body 15 that can be rotated through 90° between the two valve positions and connects the return line 8 to the feed line 5 either downstream of the oil filter 6 for single filtration of the oil to be supplied to the oil burner, or upstream of the oil filter 6 for multiple filtration of the oil to be supplied to the oil burner.

Multiple filtration of the returned oil represents a substantial improvement of the oil filter 6, in particular, when fuel consumption is small, i.e. with small flow rates of less than approximately 20 l/h. This multiple filtration improves e.g. the grade of filtration of a 5/20 μm filter element 12 (5 μm with 50% fractional collection efficiency/20 μm with 99% fractional collection efficiency) from 20 μm to 5 μm. This yields optimum filtration for small-scale consumers. This is important for interference-free operation for small-scale consumers with an extremely small nozzle consumption of e.g. 1.2 l/h (smallest bore cross-section in the oil burner nozzle). Due to multiple filtration, the pressure difference on the filter element moreover increases, in consequence of which a larger amount of air flows through the filter element 12 together with the oil. Mainly in case of small volume flows, no air or only a substantially smaller amount of air is accumulated in the filter cup 11 compared to single filtration.

Large-scale consumers, in particular, having flow rates of more than 20 l/h, can switch over to single filtration, for which reason there is only a small pressure difference at the filter element 12. The high flow rate, however, prevents accumulation of large amounts of air in the filter cup 11. When consumption is large, the grade of filtration does not have to be optimum, since nozzle bores of a corresponding large size are used. The oil filter 6 can therefore be electively adjusted to larger or smaller flow rates by means of the return changeover valve 14.

The returned oil enters a float chamber 16 of the oil deaeration device 9, in which deaeration is performed via a de-aeration valve 17 while the oil level is gradually increasing. When the oil level is approximately 20 to 30 mm above the float chamber bottom, an operational floater 18 provided in the float chamber 16 starts to surge on the oil and activate a valve 20 via a lever mechanism 19, which valve guides the deaerated return oil back to the feed line 5. The volume flow flowing to the oil burner largely consists of deaerated fuel oil and to a lesser extent of oil from the oil tank that can still contain portions of air.

As is shown in detail in FIG. 2, the check valve 7 is in the form of a ball check valve, the ball 21 of which cooperates with an opening 22 of a slidably guided valve body 23. When the ball check valve 7 is closed and an excess pressure acts on the ball 21 in the return direction, the valve body 23 is displaced by the ball 21 from its closed position, illustrated in FIG. 2, against the action of a restoring spring 24 in the return direction, i.e. in FIG. 2 in a downward direction, thereby opening a bypass opening 25. The check valve 7 with integrated pressure relief thereby prevents dangerous excess pressures in the feed line 5 which occur e.g. when the filtering and deaeration device 1 is incorrectly connected (feed hose and return hose connected in the wrong way) and can burst the oil deaeration device 9.

A manually operable bypass valve 26 is provided between the oil deaeration device 9 and the feed line 5, through which bypass valve the float chamber 16 of the oil deaeration device 9 can be connected to the feed line 5. The bypass valve 26 forms an integrated drain device which can completely or almost completely drain the oil deaeration device 9 during servicing. When the cutoff valve 27 of the tank connection 2 is closed, the operator opens the drain valve 28 on the filter cup 11 and the bypass valve 26 such that the entire oil contained in the filtering and deaeration device 1 can be discharged. By opening the bypass valve 26, an open connection is established between the return and the feed side, in consequence of which the oil present at that location can be correspondingly discharged. Aeration is thereby realized via the deaeration valve 17 of the float chamber 16. The oil must be discharged e.g. during periodic change of the burner hoses, which, up to now, always inevitably meant that oil escaped, causing corresponding soiling and bad odors.

The device 1 illustrated in FIG. 3 differs from the filtering and deaeration device of FIG. 1 in that it has no oil de-aeration device and switching over between single and multiple filtration is therefore performed on the oil filter 6 with return connection 4. Analog parts of FIG. 3 are designated with the same reference numerals as in FIG. 1.

As is illustrated by the flow arrows 10, the oil drawn from the oil tank flows via the tank connection 2 into the feed line 5 and then enters the filter cup 11 of the oil filter 6. The oil flows through the filter element 12 contained in the filter cup 11 from the outside to the inside and the subsequently filtered oil continues to flow to the feed connection 3 and is supplied to the oil burner for combustion. As is indicated by the flow arrows 13, the excess amount of delivered oil that was not supplied for combustion is supplied by the oil burner via the return connection 4 into the return line 8 and again to the feed line 5 via the return changeover valve 14. In the valve position illustrated in FIG. 3a, the return changeover valve 14 connects the return line 8 to the feed line 5 upstream of the oil filter 6 for single filtration, and in the other valve position, which is not shown, it connects the return line 8 to the feed line 5 downstream of the oil filter 6 for multiple filtration.

What is claimed is:

1. Device for filtering liquid fuel, in particular fuel oil, comprising:
a tank connection for connection to a fuel tank;
a feed connection for connection to a burner feed;
a return connection for connection to a burner fuel return;
a feed line connecting the tank connection to the feed connection;
a fuel filter disposed in the feed line;
a return line connecting the return connection to the feed line; and
a changeover valve connecting the return line to the feed line, the changeover valve being switchable between two valve positions and connects the return line to the feed line in one of the valve positions upstream of the fuel filter and connects the return line to the feed line in the other valve position downstream of the fuel filter.

2. Filtering device according to claim 1, wherein a fuel deaeration device is arranged in the return line and the return changeover valve is disposed in the return line upstream of the fuel deaeration device.

3. Filtering device according to claim 1, wherein the return changeover valve is designed as a 3/2-way valve.

4. Filtering device according to claim 1, wherein the return changeover valve can be manually operated.

5. Filtering device according to claim 1, wherein the return changeover valve has a valve body that can be rotated between the two valve positions.

6. Filtering device according to claim 1, wherein the feed line has a check valve with integrated pressure relief between the tank connection and the fuel filter.

7. Filtering device according to claim 6, wherein the check valve is in the form of a ball check valve, the ball of which cooperates with an opening of a slidably guided valve body, which, in case an excess pressure acts on the ball in the return direction, is displaced by the ball from its closed position in the return direction against the action of a restoring spring and thereby opens a bypass opening.

8. Filtering device according to claim 1, wherein a fuel deaeration device is arranged in the return line, the return changeover valve is disposed in the return line upstream of the fuel deaeration device and a bypass valve is provided between the fuel deaeration device and the feed line, through which bypass valve the fuel deaeration device can be connected to the feed line.

9. Device for filtering liquid fuel, in particular fuel oil, comprising:
a tank connection for connection to a fuel tank;
a feed connection for connection to a burner feed;
a return connection for connection to a burner fuel return;
a feed line connecting the tank connection to the feed connection,
a fuel filter disposed in the feed line,
a return line connecting the return connection to the feed line; and
a check valve with integrated pressure relief, disposed in the feed line between the tank connection and the fuel filter.

10. Filtering device according to claim 9, wherein the check valve is in the form of a ball check valve, the ball of which cooperates with an opening of a slidably guided valve body, which, in case an excess pressure acts on the ball in the return direction, is displaced by the ball from its closed position in the return direction against the action of a restoring spring and thereby opens a bypass opening.

11. Filtering device according to claim 9, wherein a fuel deaeration device is arranged in the return line, the return changeover valve is disposed in the return line upstream of the fuel deaeration device and a bypass valve is provided between the fuel deaeration device and the feed line, through which bypass valve the fuel deaeration device can be connected to the feed line.

12. Device for filtering liquid fuel, in particular fuel oil, comprising:
a tank connection for connection to a fuel tank;
a feed connection for connection to a burner feed;
a return connection for connection to a burner fuel return;
a feed line connecting the tank connection to the feed connection;
a fuel filter disposed in the feed line;
a return line connecting the return connection to the feed line;
a fuel deaeration device arranged in the return line;
a return changeover valve disposed in the return line upstream of the fuel deaeration device; and
a bypass valve provided between the fuel deaeration device and the feed line, through which the bypass valve and the fuel deaeration device can be connected to the feed line.
